(19) United States
(12) Patent Application Publication
(10) Pub. No.: US 2013/0329600 A1
(43) Pub. Date: Dec. 12, 2013

(54) METHOD AND APPARATUS FOR NEGOTIATING CAPABILITIES IN A WIRELESS COMMUNICATION NETWORK ENVIRONMENT

(71) Applicant: Samsung Electronics Co., Ltd., Gyeonggi-do (KR)

(72) Inventors: Kiran Bharadwaj VEDULA, Bangalore (IN); Venkateswar JEEDIGUNTA, Bangalore (IN)

(73) Assignee: Samsung Electronics Co., Ltd.

(21) Appl. No.: 13/915,043

(22) Filed: Jun. 11, 2013

(30) Foreign Application Priority Data
Jun. 11, 2012 (IN) 2316/CHE/2012

(51) Int. Cl. H04W 76/02

(52) U.S. Cl. CPC H04W 76/023
USPC 370/254

(57) ABSTRACT

A method and system for negotiating capabilities in a wireless communication network are provided. The method includes generating an action frame including one or more information elements, where the one or more information elements include capability information for multiple frequency bands. The method further includes transmitting the action frame including the one or more information elements to wireless communication devices in a wireless communication network.

### CROSS-REFERENCE TO RELATED PATENT APPLICATION

This application claims the benefit under 35 U.S.C. §119(a) of an Indian Patent Application filed in the Indian Patent Office on Jun. 11, 2012 and assigned Serial No. IN 2316/CHE/2012, the entire disclosures of which are hereby incorporated by reference.

### FIELD OF THE INVENTION

The present invention generally relates to the field of wireless communications, and more particularly relates to a method and system for negotiating capabilities in a wireless communication network environment.

### BACKGROUND OF THE INVENTION

Wireless communication devices (e.g., Wi-Fi Direct and Wi-Fi Display devices) typically operate within certain radio frequency ranges or band established by one or more communication standards or protocols. The 2.4 GHz band that encompasses current Wi-Fi and Bluetooth™ Protocols have limited data throughput. A newer 60 GHz standard ensures higher throughput upto 7 Gbps in a short range wireless data transmissions. Using 60 GHz technology, high rate data transfers such as real time uncompressed/compressed high-definition (HD) video and audio streams may be transferred between two devices. Some examples of transfers between two wireless communication devices under access point (AP) or PBSS Control Point (PCP) control include data transfers between a conference room projector and a laptop, between camcorder and display or between a network storage server and a laptop.

In order that wireless communication devices supporting 60 GHz technology discover, establish connection and communicate with other wireless communication devices in a wireless communication network environment, wireless communication devices need to negotiate capability information related to 60 GHz technology with other wireless communication devices in the wireless communication network environment. However, current Wi-Fi specifications (e.g., Wi-Fi Direct Specification and Wi-Fi Display specification) based on IEEE 802.11 standard do not specify provisions for negotiating capability information related to 60 GHz technology with other wireless communication devices.

### BRIEF DESCRIPTION OF THE ACCOMPANYING DRAWINGS

FIG. 1 is a block diagram illustrates a wireless communication network, according to one embodiment.

FIG. 2 is a process flowchart illustrating an exemplary method of communicating capability information in the wireless communication network, according to one embodiment.

FIG. 3 is a schematic representation illustrating an exemplary action frame carrying information elements, according to one embodiment.

FIG. 4 illustrates a format of an exemplary Peer to Peer (P2P) Information Element (IE) used for communicating capability information to wireless communication devices, according to one embodiment.

FIG. 5 illustrates a format of an exemplary Wi-Fi Display (WFD) Information Element (IE) used for communicating capability information with wireless communication devices, according to one embodiment.

FIG. 6 is a schematic representation illustrating an exemplary raw video format sub element, according to one embodiment.

FIG. 7 is a schematic representation illustrating an exemplary multi stream capability sub element, according to one embodiment.

FIG. 8 is a block diagram of an exemplary wireless communication device, such as those shown in FIG. 1, showing various components for implementing embodiments of the present subject matter.

The drawings described herein are for illustration purposes only and are not intended to limit the scope of the present disclosure in any way.

### DETAILED DESCRIPTION OF THE INVENTION

The present invention provides a method and system for negotiating capabilities in a wireless communication network. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

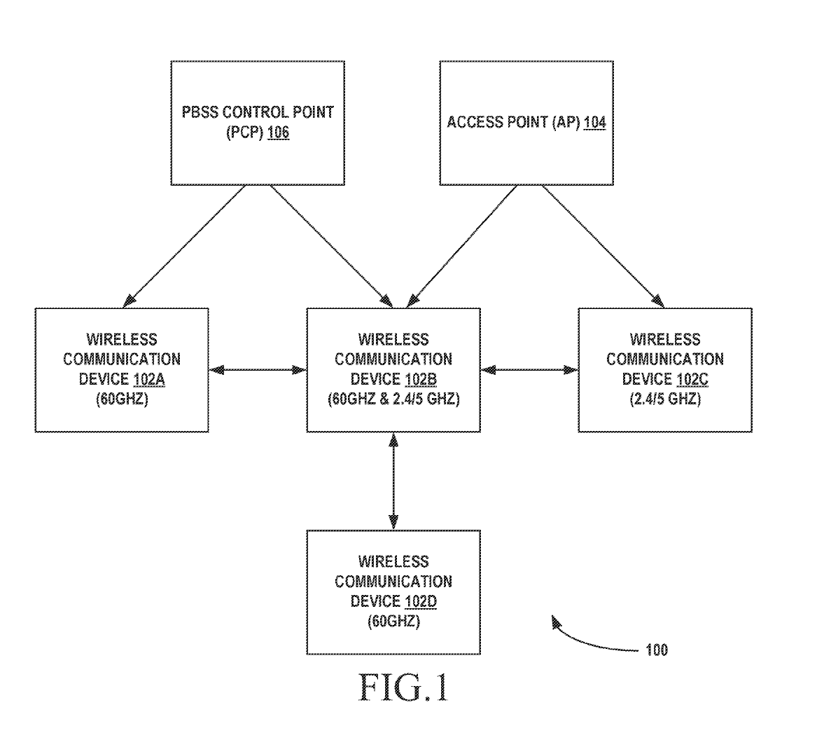

FIG. 1 is a block diagram illustrates a wireless communication network 100, according to one embodiment. In FIG. 1, the wireless communication network 100 includes wireless communication devices 102A-D. The wireless communication devices 102A-D may include Wireless Fidelity (Wi-Fi) direct devices, Peer to Peer (P2P) devices, IEEE 802.11ad devices and Wireless Gigabit (WiGig) devices. Exemplary wireless communication devices 102A-D may include display device, a printer, a digital camera, a projector, and a mobile phone. Further, the wireless communication devices 102A-D are capable of operating on 2.4/5 GHz and 60 GHz frequency bands.

The wireless communication devices 102A-D may be connected to each other through an access point (AP) 104 or a PCP 106. The wireless communication devices 102A-D connected to each other form a P2P group. In the P2P group, one of the wireless communication devices 102A-D becomes an owner of the P2P group. The role of group owner is assigned to a wireless communication device based on operating frequency band. That is, if the wireless communication device supports 2.4 GHz and has high intent value as compared to other wireless communication devices, then the wireless communication device is designated as group owner of P2P group for communication with devices over 2.4/5 GHz frequency band. However, while communicating over 60 GHz frequency band, the same wireless communication device, which is the owner of the P2P group during communication over 2.4/5 GHz frequency band, may not be owner of P2P group for communication with one or more devices over 60 GHz frequency as the PCP factor of the wireless communication device may not be highest among the other devices. In such case, another wireless communication device supporting 60 GHz frequency band and having high PCP factor is designated role of group owner of the P2P group.

Thus, when the wireless communication devices support multiple bands and have different intent value and PCP factor, role of group owner is designated based on whether the wireless communication device supports a particular frequency band and have high intent value/PCP factor. According to the present invention, each of the wireless communication devices 102A-D generates and transmits action frames with information elements carrying capability information for multiple frequency bands such as support for multiple frequency bands and intent value/PCP factor as described in the following description.

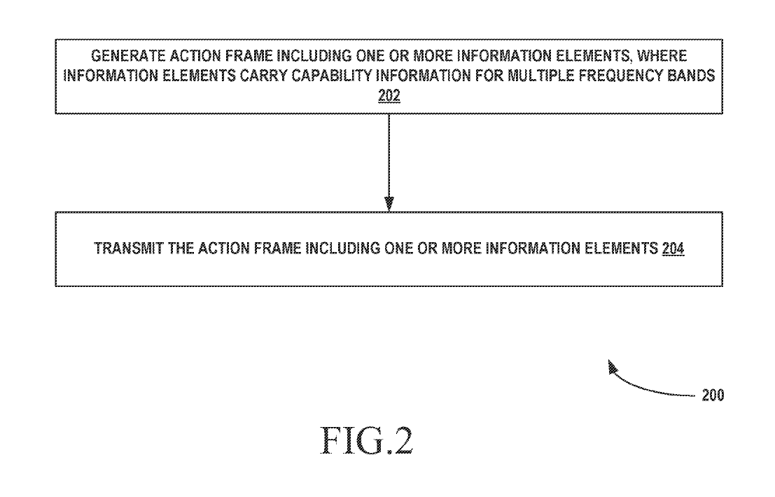

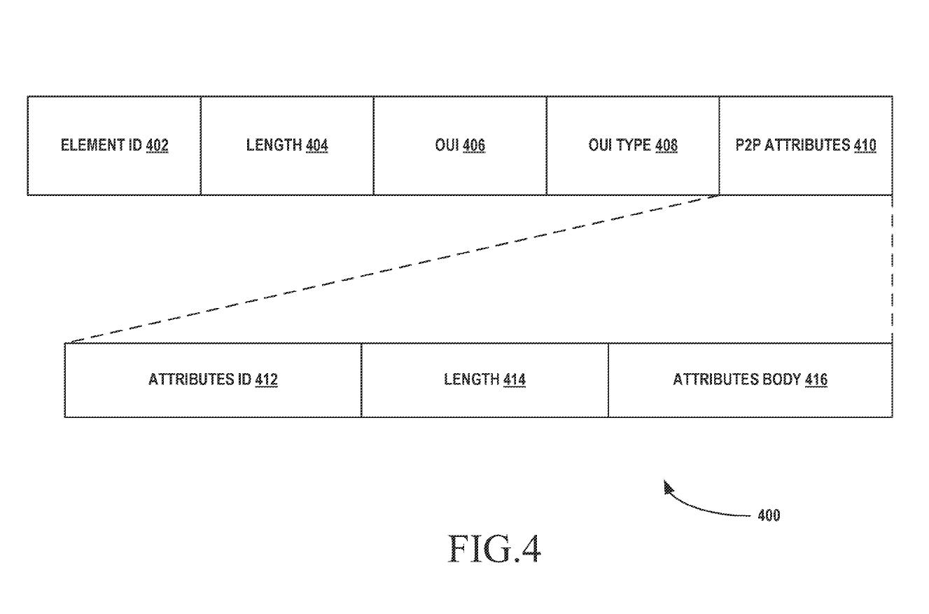

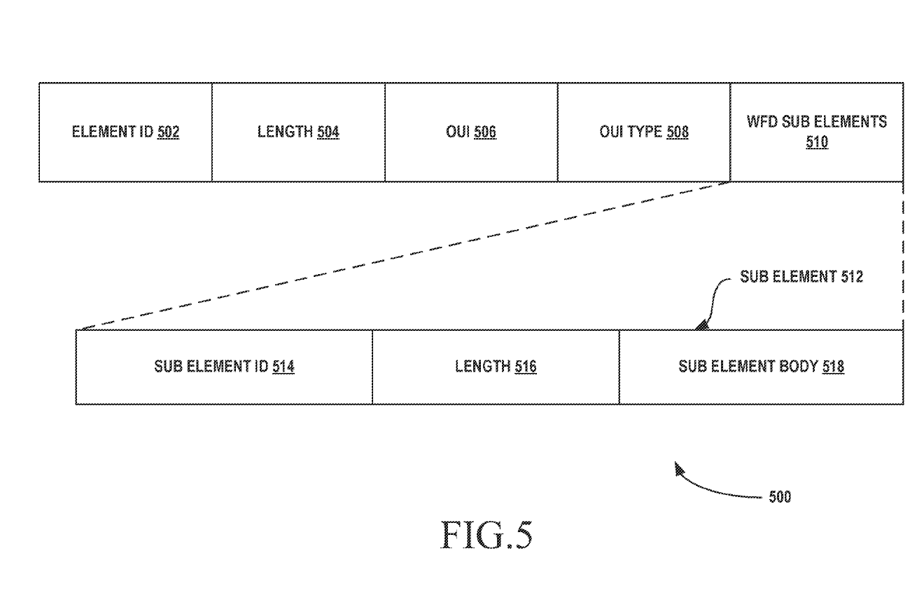

FIG. 2 is a process flowchart 200 illustrating an exemplary method of negotiating capabilities in the wireless communication network 100, according to one embodiment. At step 202, an action frame with one or more information elements including capability information for multiple frequency bands is generated. The action frame may be a Beacon frame, Dband Beacon frame, announcement frame, probe request frame, probe response frame, information request frame, information response frame and so on. The information elements may be a Peer to Peer (P2P) information elements and Wi-Fi Display information elements. The P2P information elements include P2P capability information, support for multiple frequency band, group owner (GO) intent value, PCP factor, Dband operating channel information, Dband capability information and Dband operation information, support for PBSS Control Point (PCP) handover, support for Fast Session Transfer (FST), FST data, support seamless session maintenance (SSM), and SSM data. Exemplary P2P information element is illustrated in FIG. 4. The WFD information elements include WFD device information, associated BSSID, WFD video formats, WFD extended capability information, WFD session information, RAW video format information, support for multiple streams, multi-stream capability information, support for SSM, and SSM data. Exemplary P2P information element is illustrated in FIG. 5. At step 204, the action frame including the information elements is transmitted to one or more wireless communication devices in the wireless communication network.

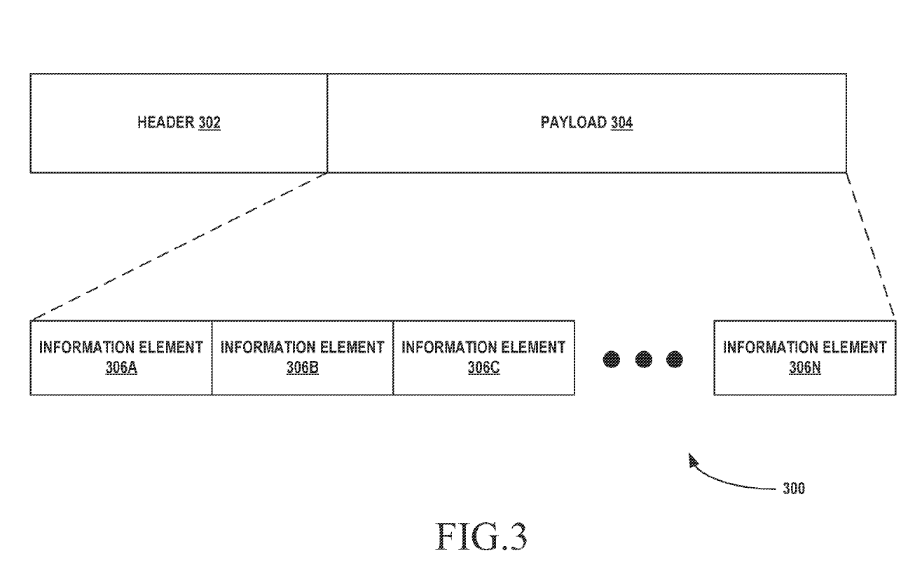

FIG. 3 is a schematic representation illustrating an exemplary action frame 300 carrying information element, according to one embodiment. The action frame 300 includes a header field 302 and a payload field 304. The payload field 304 carries one or more information elements 306A-N. In one exemplary implementation, the one or more information elements may be P2P information elements. In another exemplary implementation, the one or more information elements may be WFD information elements. The information elements carry capability information as detailed above.

FIG. 4 illustrates a format of an exemplary Peer to Peer (P2P) Information Element (IE) 400 used for communicating capability information to peer wireless communication devices, according to one embodiment. As mentioned earlier, the P2P IE 400 is transmitted to the wireless communication devices in an action frame such as Beacon frame, Dband Beacon frame, announcement frame, probe request frame, probe response frame, information request frame, information response frame and so onwhich complies with formats defined in the IEEE 802.11 specification and the Wi-Fi Direct specification.

The P2P IE 400 includes an element ID field 402, a length field 404, an OUI field 406, an OUI type field 408, and P2P attributes field 410. The element ID field 402 indicates value which identifies the information element 400 as ‘P2P IE’. The length field 404 includes value identifying length of the P2P information element 400. The OUI field 406 includes an Organizational Unique Identifier value as defined by the Wi-Fi specification. The OUI type field 408 indicates type of the Organizational Unique Identifier as defined by the Wi-Fi Specification.

The P2P attributes field 410 includes content of the P2P information elements. The P2P attributes field 410 may include an attribute ID field 412, a length field 414, and an attributes body field 416. The attribute ID field 412 indicates a type of attribute. For example, the attribute ID field 412 is set to ‘2’ when the attributes body field 416 indicates a P2P capability. The attributes body field 416 has a device capability bitmap field containing bits 6 and 7 reserved in Wi-Fi Display 1.0 specification. According to the present invention, the bit 6 indicates support for multi-band. For example, the bit 6 in the device capability bitmap field is set to ‘1’ when wireless communication device has multi-band capability. However, if the wireless communication device is not Multi-Band capable, then the bit 6 in the device capability bitmap field is set to ‘0’.

The attribute ID field 412 is set to ‘4’ when the attribute body field 416 indicates intent to become an owner of a P2P group. The attribute body field 416 may contain value of intent to become an owner of a P2P group. The value may range from 0 to 15. A value of ‘15’ indicates highest intent. It can be noted that, when the attribute ID field 412 is set to ‘4’, the attribute body field 416 indicates intent to become an owner of a group of devices capable of operating on 2.4 GHz band.

The attributes ID field 412 is set to ‘19’ when the attributes body field 416 indicates Dbandlisten channel. The Dband channel is 60 GHz channel in which the wireless communication device will be listening. The attributes ID field 412 is set to ‘20’ when the attributes body field 416 indicates Dband operating channel. The Dband operating channel is 60 GHz channel in which the wireless communication device will be operating. The attributes ID field 412 is set to ‘21’ when the attributes body field 416 indicates Dband capabilities. The Dband capabilities indicate 60 GHz specific capabilities of the wireless communication device such as directionality. The attributes ID field 412 is set to ‘22’ when the attributes body field 416 indicates Dband operation. The attributes body field 416 is set when the wireless communication device is operating in 60 GHz frequency band.

The attributes ID field 412 is set to ‘23’ when the attributes body field 416 indicates various combinations of support for multiple frequency band. According to the present invention, the attributes body field 416 is set to value ‘0’ when the wireless communication device is a Wi-Fi direct device supporting 2.4 GHz/5 GHz band. The attributes body field 416 is set to value ‘1’ when the wireless communication device is a Wi-Fi direct device supporting 60 GHz and 2.4 GHz/5 GHz bands. The attributes body field 416 is set to value ‘2’ when the wireless communication device is a P2P device supporting a 60 GHz band. The attributes body field is set to value ‘3’ when the wireless communication device is a 60 GHz certified device (e.g., IEEE 802.11ad or WiGig device). It can be noted that the values 4 to 7 are reserved for future topologies.

The attributes ID field 412 is set to ‘24’ when the attributes body field 416 indicates that PBSS Control Point (PCP) handover is supported. According to the present invention, the attributes body field 416 is set to value ‘1’ if the wireless communication device supports PCP handover. Alternatively, if the wireless communication device does not support PCP handover, the attributes body field 416 is set to value ‘0’.

The attributes ID field 412 is set to ‘25’ when the attributes body field 416 indicates that FST is supported. According to the present invention, the attributes body field 416 is set to value ‘1’ if the wireless communication device supports FST. Alternatively, if the wireless communication device does not support FST, the attributes body field 416 is set to value ‘0’. The attributes ID field 412 is set to ‘26’ when the attributes body field 416 contains FST data. The FST data may indicate operating class, operating channel, possible FST bands and transfer timeout/latency information. The operating class information indicates a frequency band in which the wireless device is currently operating. The operating channel information indicates a channel in which the wireless device is currently operating. The possible FST bands information indicate one or more bands to which the wireless device can transfer its operation. The transfer timeout/latency information indicates time duration within which a frequency band in which the wireless device is currently operating is likely to be transferred.

The attributes ID field 412 is set to ‘27’ when the attributes body field 416 indicates that SSM is supported. According to the present invention, the attributes body field 416 is set to value ‘1’ if the wireless communication device supports SSM. Alternatively, if the wireless communication device does not support SSM, the attributes body field 416 is set to value ‘0’. The attributes ID field 412 is set to ‘28’ when the attributes body field 416 includes SSM data. The SSM data includes session transfer timeout, operating codec, supported codecs, and session throughput information. The session transfer timeout information indicates the time within which a session is to be transferred from one wireless device to another wireless device. The operating codecs information indicates codec that is being used during ongoing session. The supported codecs information indicates additional codecs that are supported in the ongoing session. The session throughput information indicates throughput that is achieved during the ongoing session.

The attributes ID field 412 is set to ‘29’ when the attributes body field 416 contains Personal Basic Service Set Identification (PBSSID). The attributes ID field 412 is set to ‘30’ when the attributes body field 416 indicates PBSS Control Point (PCP) factor. The PCP factor indicates intent of the wireless device to become an owner of group of wireless devices operating on 60 GHz band. One skilled in the art will understand that the group owner intent is used to indicate owner of group of wireless devices supporting 2.4 GHz band while PCP factor is used to indicates owner of group of wireless devices supporting 60 GHz band. When a wireless device is capable of operating on 2.4 GHz band and 60 GHz band, then the wireless device indicates both group owner intent and PCP factor to the group of wireless devices.

It can be noted that attributes IDs 31-220 are reserved for future use.

FIG. 5 illustrates a format of an exemplary Wi-Fi Display (WFD) Information Element (IE) 500 used for communicating capability information with peer wireless communication devices, according to one embodiment. As mentioned earlier, the WFD IE 500 is transmitted to the wireless communication devices in an action frame such as Beacon frame, Dband Beacon frame, announcement frame, probe request frame, probe response frame, information request frame, information response frame and so on.

The WFD IE 500 includes an element ID field 502, a length field 504, an OUI field 506, an OUI type field 508, and WFD sub elements field 510. The element ID field 502 indicates value which identifies the information element 500 as ‘WFD IE’. The length field 504 includes value identifying length of the WFD information element 500. The OUI field 506 includes an Organizational Unique Identifier value as defined by the Wi-Fi specification. The OUI type field 508 indicates type of the Organizational Unique Identifier as defined by the Wi-Fi Specification.

The WFD sub elements field 510 contains one or more sub elements 512 carrying content of the WFD IE 500. Each sub element 512 may include a sub element ID field 514, a length field 516, and sub element body field 518. The sub element ID indicates a unique identifier associated with a sub element in the sub element body field 518. The sub element ID may contain values ranging from 0-10 according to the existing WFD specification 1.0. According to the present invention, the sub element ID may contain values ranging from 0-255, where some of the sub element IDs 11-255 are provided to support 60 GHz technology. In an exemplary implementation, the sub element ID field 514 is set to a value ‘0’ when the sub element body field 518 includes WFD device information. Currently, in the WFD device information, bits 14 and 15 are reserved bits. According to the present invention, the bit 14 is used to indicate support for 60 GHz band. For example, the bit 14 of the WFD device information is set to a value ‘0’ when the wireless communication device does not support 60 GHz band. However, when the wireless communication device support 60 GHz band, then the bit 14 is set to a value ‘1’.

The sub element ID field 514 is set to a value ‘1’ when the sub element body field 518 indicates associated BSSID. The associated BSSID contains address of group owner or access point connected to the wireless communication device when the wireless communication device supports 2.4/5 GHz band. Similarly, the associated BSSID contains address of PCP connected to the wireless communication device when the wireless communication device supports 60 GHz band.

The sub element ID field 514 is set to a value ‘3’ when the sub element body field 518 indicates WFD video formats such as H.264 Base Profile, H.264 Advanced Base Profile etc. The sub element ID field 514 is set to a value ‘7’ when the sub element body field 518 indicates WFD extended capability. The sub element ID field 514 indicates WFD extended capability information in 0 to 15 bits, where bits 6 to 15 are reserved bits as defined in the existing Wi-Fi Display specification. According to the present invention, bit 6 of the WFD extended capability is used to indicate interactivity support by the wireless communication device. For example, the bit 6 is set to a value ‘0’ if the wireless communication device does not support interactivity. On the other hand, the bit 6 is set to a value ‘1’ if the wireless communication device supports interactivity.

The sub element ID field 514 is set to a value ‘9’ when the sub element body field 518 includes WFD session information. The WFD session information contains device information of all WFD devices in a group.

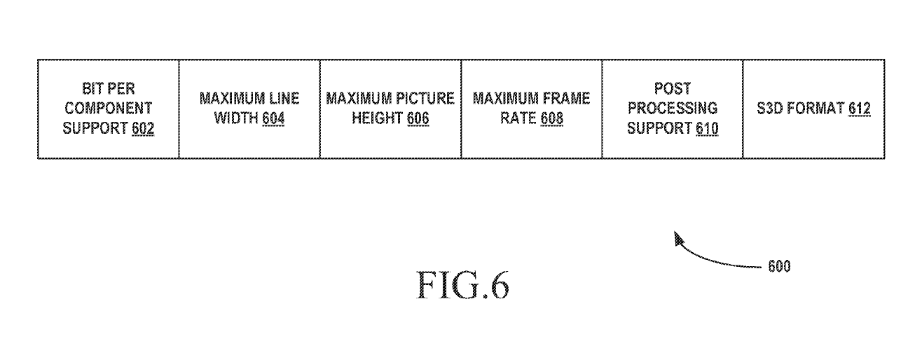

The sub element ID field 514 is set to a value ‘11’ when the sub element body field 518 indicates raw video format. An exemplary sub element for raw video format 600 is illustrated in FIG. 6. Referring to FIG. 6, the sub element body field 518 includes a bit per component support field 602, a maximum line width field 604, a maximum picture height field 606, a maximum frame rate field 608, a post-processing support field 610, and S3D format field 612. One skilled in the art would appreciated that the fields 602 to 612 of the raw video format 600 are same as a raw video format defined in WiGig Display Extension (WDE) specifications.

The sub element ID field 514 is set to a value ‘12’ when the sub element body field 518 indicates multi stream support. For example, the sub element body field 518 may be set to value ‘0’ if the wireless communication device does not support multiple streams. If the wireless communication device supports multiple streams then the sub element body field 518 is set to value ‘1’.

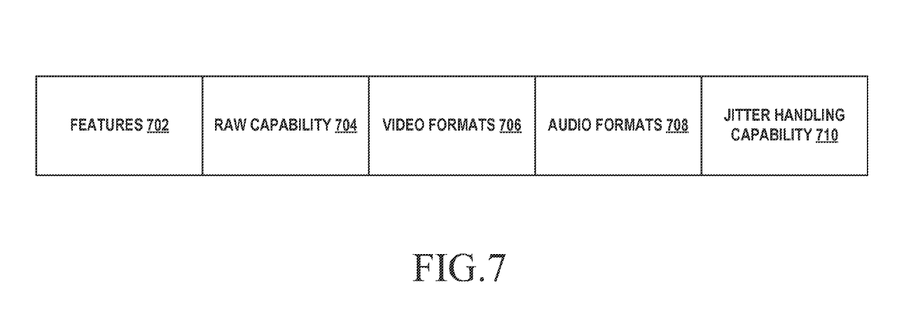

The sub element ID field 514 is set to a value ‘13’ when the sub element body field 518 indicates multi stream capability of the wireless communication device. An exemplary sub element body field 518 indicating the multi stream capability is shown in FIG. 7. The sub element body field 518 may include a features field 702, a raw capability field 704, a video format field 706, an audio format field 708, and a jitter handling capability field 710. The feature field 702 may indicate features supported by the wireless communication device. The feature field 702 may contain two byte information, where the first byte may be set to value ranging from 0 to 7 and the second byte may be set to values 0 and 1 depending on the features supported by the wireless communication device. For example, the values set in the first byte and the second byte and corresponding features are illustrated in Table 1 below:

TABLE 1

| | Features |
|---|---|
| Bit (first byte) | |
| 0 | AVC video |
| 1 | Uncompressed video |
| 2 | WSP video |
| 3 | VendorSpecific video |
| 4 | Audio format 1 |
| 5 | Audio Format 2 |
| 6 | Static recovery |
| 7 | Application FEC |
| Bit (second byte) | |
| 0 | DisplayPort mapping |
| 1 | HDMI mapping |
| Others | reserved |

The raw capability field 704 indicates capability to support raw video format. The video formats field 706 indicates video formats supported by the wireless communication device. The audio formats field 708 indicates audio formats supported by the wireless communication device. The jitter handling capability 710 indicates capability of the wireless communication device to handle jitters.

The sub element ID field 514 is set to a value ‘14’ when the sub element body field 518 indicates support for seamless session maintenance (SSM) feature by the wireless communication device. For example, the sub element body field 518 is set to a value ‘1’ if the wireless communication device supports SSM feature. However, if the wireless communication device is set to a value ‘0’, then the sub element body field 518 is set to a value ‘0’.

The sub element ID field 514 is set to ‘15’ when the sub element body field 518 includes SSM data. The SSM data includes session transfer timeout, operating codec, supported codecs, and session throughput information. The session transfer timeout information indicates the time within which a session is to be transferred from one wireless communication device to another wireless communication device. The operating codecs information indicates codec that is being used during ongoing session.

The supported codecs information indicates additional codecs that are supported in the ongoing session. The session throughput information indicates throughput that is achieved during the ongoing session.

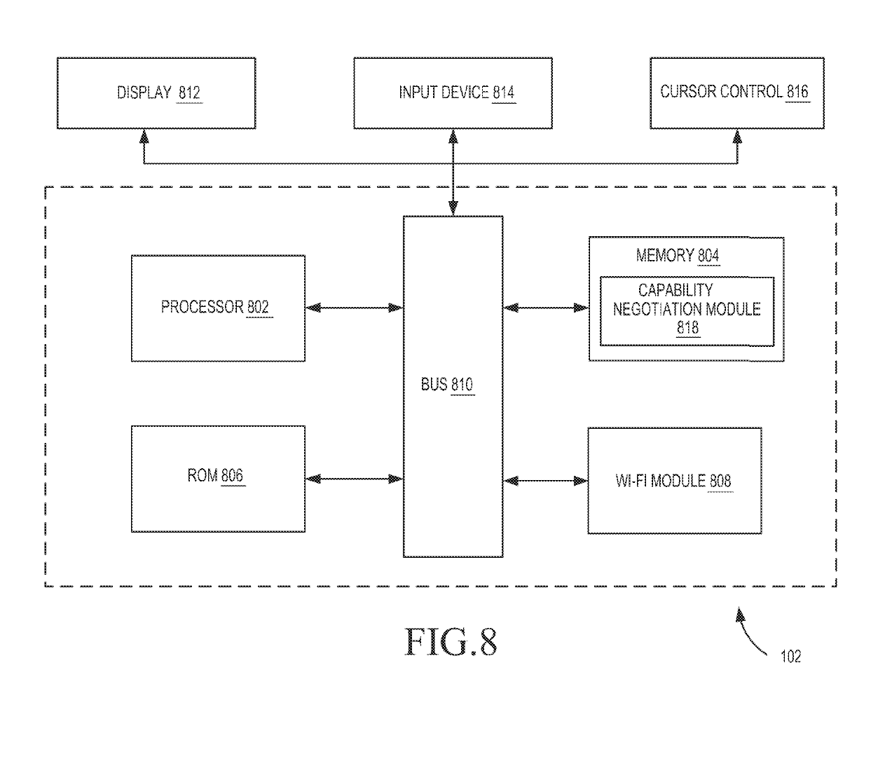

FIG. 8 is a block diagram of the wireless communication device 102 showing various components for implementing embodiments of the present subject matter. In FIG. 8, the wireless communication device 102 includes a processor 802, memory 804, a read only memory (ROM) 806, a transceiver 808, a bus 810, a display 812, an input device 814, and a cursor control 816.

The processor 802, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 802 may also include embedded controllers, such as generic or programmable logic devices or arrays, application specific integrated circuits, single-chip computers, smart cards, and the like.

The memory 804 and the ROM 806 may be volatile memory and non-volatile memory. The memory 804 includes a capability negotiation module 818 configured for generating and transmitting action frames with information elements carrying capability information, according to one or more embodiments described above. A variety of computer- readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, and the like.

Embodiments of the present subject matter may be implemented in conjunction with modules, including functions, procedures, data structures, and application programs, for performing tasks, or defining abstract data types or low-level hardware contexts. The capability negotiation module 818 may be stored in the form of machine-readable instructions on any of the above-mentioned storage media and may be executed by the processor 802. For example, a computer program may include machine-readable instructions, that when executed by the processor 802, cause the processor 802 to generating and transmitting action frames with information elements carrying capability information, according to the teachings and herein described embodiments of the present subject matter. In one embodiment, the computer program may be included on a compact disk-read only memory (CD-ROM) and loaded from the CD-ROM to a hard drive in the non-volatile memory.

The Wi-Fi module 808 may be capable of transmitting/receiving action frames to/from other wireless communication devices in the wireless communication network 100. The bus 810 acts as interconnect between various components of the wireless communication device 102. The components such as the display 812, the input device 814, and the cursor control 816 are well known to the person skilled in the art and hence the explanation is thereof omitted.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

We claim:

1. A method of negotiating capabilities in a wireless communication network environment, comprising:
generating an action frame comprising one or more information elements, wherein the one or more information elements comprises a multiband capability indicator and intent to become owner of a Peer to Peer (P2P) group; and
transmitting the action frame including the one or more information elements to one or more peer wireless communication devices in the wireless communication network environment.

2. The method of claim 1, wherein the one or more information elements comprise Peer to Peer (P2P) information elements.

3. The method of claim 1, wherein the one or more information elements comprise Wi-Fi Display (WFD) information elements.

4. The method of claim 1, wherein the multiband capability indicator indicates capability to support multiple bands.

5. The method of claim 1, wherein the intent to become the owner of the P2P group comprises a group owner intent value and a PBSS Control Point (PCP) factor.

6. The method of claim 5, wherein the intent value indicates intent to become owner of the P2P group during communication over a 2.4/5 frequency band.

7. The method of claim 5, wherein the PCP factor indicates intent to become owner of the P2P group during communication over 60 GHz frequency band.

8. The method of claim 1, wherein the action frame comprises at least one information element indicating support for uncompressed media data.

9. The method of claim 8, wherein the at least one information elements comprises sub elements indicating support for raw video format, support for multiple streams, support for fast session transfer (FST), support for seamless session maintenance feature, and capabilities for each of the multiple streams.

10. An apparatus comprising:
a processor configured for generating an action frame comprising one or more information elements, wherein the one or more information elements comprises capability information for multiple frequency bands; and
a Wi-Fi module configured for transmitting the action frame including the one or more information elements to one or more peer wireless communication devices in the wireless communication network environment.

11. The apparatus of claim 10, wherein the one or more information elements comprise Peer to Peer (P2P) information elements.

12. The apparatus of claim 10, wherein the one or more information elements comprise Wi-Fi Display (WFD) information elements.

13. The apparatus of claim 10, wherein the capability information for multiple frequency bands comprises a multiband capability indicator, intent to become owner of a P2P group, support for raw video format, support for uncompressed media data, support for multiple streams, support for fast session transfer (FST), support for seamless session maintenance feature, and capabilities for each of the multiple streams.

14. The apparatus of claim 13, wherein the multiband capability indicator indicates capability to support multiple bands.

15. The apparatus of claim 13, wherein the intent to become the owner of the P2P group comprises a group owner intent value and a PBSS Control Point (PCP) factor.

16. The apparatus of claim 15, wherein the intent value indicates intent to become owner of the P2P group during communication over a 2.4/5 frequency band.

17. The apparatus of claim 15, wherein the PCP factor indicates intent to become owner of the P2P group during communication over 60 GHz frequency band.

18. A non-transitory computer-readable storage medium having instructions stored therein, that when executed by a wireless communication device, cause the wireless communication device to perform a method comprising:
generating an action frame comprising one or more information elements, wherein the one or more information elements comprises capability information for multiple frequency bands; and
transmitting the action frame including the one or more information elements to one or more wireless communication devices in the Wi-Fi network environment.

19. The storage medium of claim 18, wherein the capability information for multiple frequency bands comprises a multiband capability indicator, intent to become owner of a Peer to Peer (P2P) group, support for raw video format, support for multiple streams, support for fast session transfer (FST), support for seamless session maintenance feature, and capabilities for each of the multiple streams.
